(19) United States
(12) Patent Application Publication
(10) Pub. No.: US 2023/0121874 A1
(43) Pub. Date: Apr. 20, 2023

(54) Integrated Optical Switch Having Doped Fiber/Waveguide Amplifiers Packaged in A Transposer

(71) Applicant: Mellanox Technologies, Ltd., Yokneam (IL)

(72) Inventors: Paraskevas Bakopoulos, llion (GR); Ioannis Giannis Patronas, Athens (GR); Dimitris Kalavrouziotis, Papagou (GR); Juan Jose Vegas Olmos, Solrød Strand (DK); Elad Mentovich, TEL AVIV (IL); Nikos Argyris, Zografou (GR)

(21) Appl. No.: 17/519,411

(22) Filed: Nov. 4, 2021

(30) Foreign Application Priority Data
Oct. 19, 2021 (GR) 20210100714

(51) Int. Cl. G02B 6/42; G02B 6/43

(52) U.S. Cl. CPC G02B 6/4215; G02B 6/43; G02B 6/2938

(57) ABSTRACT

The disclosure addresses the problem of increased optical insertion losses in integrated optical switches. It enables the implementation of an array of optical amplifiers, typically with low/moderate gain, to compensate for optical insertion losses in the integrated switches. The amplifier is based on a doped optical fiber which is optically pumped by a pump laser. The integrated optical switch includes a transposer that facilitates connectivity between a set of fibers and a photonic chip through an optical mode conversion. An all passive circuitry is built in a doped fiber amplifier, WDM couplers combine/separate the signals from the pump, and splitters allow sharing of a single pump by multiple amplifiers. In addition, switch pigtails are implemented with the doped fiber.

### CROSS REFERENCE TO RELATED APPLICATIONS

This application claims the benefit of priority to the Greece Patent Application No. 20210100714, filed Oct. 19, 2021, titled “INTEGRATED OPTICAL SWITCH HAVING DOPED FIBER/WAVEGUIDE AMPLIFIERS PACKAGED IN A TRANSPOSER,” which is incorporated by reference herein in its entirety.

### TECHNICAL FIELD

The application relates to the field of photonics. In particular, embodiments are described that relate to an integrated optical switching circuit.

### BACKGROUND

Datacenters are the storage and data processing hubs of the internet. The massive deployment of cloud applications is causing datacenters to expand exponentially in size, resulting in the development of faster switches in order to handle the increasing volume and speed required for data traffic inside the datacenters. Current state-of-the-art switches are capable of handling 25.6 Tb/s of traffic by employing ASIC chips equipped with 512 data lanes, each of them operating at 50 Gb/s. Such switching ASICs typically consume more than 400 W, whereas the additional power consumption of the optical transceiver interfaces attached to the ASICs is comparably large. Therefore, the datacenter's switch capacity has to be doubled approximately every 2 years just to keep up with such high traffic demand.

So far, this rapid scaling has been made possible by taking advantage of the advances in CMOS manufacturing technology, guided by Moore's law (i.e., the observation that the number of transistors in a dense integrated circuit doubles about every two years). However, in recent years there are indications that Moore's law has gradually slowed down, which has raised concerns as to whether the capability to the target scaling rate of switch capacity can be sustained. Alternative technology approaches have been identified, for example, the co-integration of photonics and electronics in multi-chip modules, which is expected to enable the development of datacenter switches with up to 100 Tb/s capacity. However, it is expected that further scaling will not be possible in a way that is viable from the technological, economical, and power consumption perspectives. As a result, alternative technologies are being investigated.

Today datacenters face a multitude of challenges, mainly involving enabling the aggressive scaling of bandwidth and system size, while keeping network energy consumption and latency low. Optical switching bears the promise of disrupting current scaling trends and providing broad bandwidth with lower latency and meagre energy consumption. However, practical deployment of optical switching in the datacenters requires tens to hundreds of thousands of ports for each installation. The cost and bulk volume of current commercial optical switches render such deployment nearly prohibitive; therefore, a shift to photonic integrated switches is considered essential to tap the datacenter applications. On the other hand, photonic integrated switches typically exhibit high insertion losses, which render them incompatible with widely used short-reach transceiver types. Therefore, a viable way to design and manufacture amplified optical integrated switches is necessary.

The current available solutions have failed to solve these problems. Efforts towards amplified photonic integrated switches have focused so far on the use of III-V semiconductor materials which can provide optical gain, e.g., semiconductor optical amplifiers (SOAs). Two different technologies have been proposed—a monolithic one and a hybrid one:
1) Monolithic chips on InP combining switch blocks with gain blocks, and
2) Hybrid or heterogeneously integrated III-V gain blocks (SOAs) on silicon.

Both approaches are suffering from practical limitations that are hindering their commercial deployment. Overall, SOAs exhibit moderate noise, which therefore degrades optical signal integrity. Cascade ability of SOAs is also limited due to the accumulation of broadband amplified spontaneous emission (ASE) noise of the amplifiers, which causes saturation of all amplifiers in the link, thus reducing their gain. In addition, electrically driven components SOAs also dissipate heat, typically in the order of hundreds of milliwatts per unit. Therefore, integration of multiple SOAs on a single chip requires sophisticated cooling solutions to ensure that the SOA temperature remains within acceptable levels, thereby avoiding significant drop in the amplifier's gain.

In the case of monolithic III-V chips, even moderate switch radii result in large chips due to the low index contrast of typical III-V waveguide designs. Fabricating such chips with a high yield is an outright challenge, particularly considering that III-V process factories are not as advanced as their CMOS counterparts.

In the case of hybrid or heterogeneously integrated III-V gain blocks on silicon, the challenge comes with the integration process of the III-V material with the silicon wafer. Various approaches have been proposed in the literature, but practical implementation with high yield is yet to be demonstrated.

### SUMMARY

The embodiments of the invention described herein provide a way to implement multiple doped-fiber amplifiers closely integrated with a photonic integrated circuit, using an optical transposer.

According to one embodiment of the present invention, an integrated optical switch is provided. The integrated optical switch comprises a photonic integrated switch circuit; a pump laser, emitting a pump light into a laser output fiber, wherein the pump light comprises a first wavelength; a plurality of first fibers, wherein each of the plurality of first fibers has a first end connecting to an optical connector, wherein said fibers are doped; and a transposer configured to be set between the plurality of first fibers and the photonic integrated switch circuit.

The transposer may comprise an optical splitter, wherein an input end of the optical splitter receives the pump light by connecting to the laser output fiber, and wherein output ends of the optical splitter carries divided pump light. The transposer may also comprise a plurality of first waveguides. The plurality of first waveguides may be doped, wherein a first end of one of the plurality of first waveguides connects to a second end of one of the plurality of first fibers. The transposer may also comprise a plurality of second waveguides, wherein a first end of one of the plurality of second waveguides connects to the photonic integrated switch circuit, and a plurality of third waveguides, wherein a first end of one of the plurality of third waveguides connects to one of the output ends of the optical splitter respectively.

In some embodiments, the transposer may also comprise a plurality of wavelength division multiplexers, wherein one of the plurality of second waveguides is multiplexed with one of the plurality of third waveguides into one of the plurality of first waveguides respectively. The plurality of second waveguides may comprise a first signal having a second wavelength, herein the second wavelength may include multiple wavelengths within a wavelength band, and the plurality of first fibers may comprise a second signal, wherein the second signal is an amplified first signal, and wherein the second signal comprises the second wavelength.

In some examples, each of the plurality of wavelength division multiplexers includes a first terminal, a second terminal, and a third terminal, the first terminal of one of the plurality of wavelength division multiplexers connects to a second end of one of the plurality of first waveguides which connects to the plurality of first fibers, the second terminal of one of the plurality of wavelength division multiplexers connects to a second end of one of the plurality of second waveguides from the photonic integrated switch circuit; and a third terminal of plurality of wavelength division multiplexers connects to a second end of one of the plurality of third waveguides from the optical splitter.

In some examples, each of the plurality of second waveguides is multiplexed with one of the plurality of third waveguides.

In some examples, the first wavelength of the pump laser is shorter than the second wavelength of the first signal.

In some examples, integrated optical switch further comprises an optical isolator in the optical connector of one of the plurality of first fibers, wherein the optical isolator suppresses reflections back into the doped fiber which would cause instability to the operation of the amplifier.

In some examples, integrated optical switch further comprises a mode conversion structure between one of the plurality of second waveguides and the photonic integrated switch circuit.

In some examples, integrated optical switch further comprises an optical isolator between one of the plurality of second waveguides and the photonic integrated switch circuit, wherein the optical isolator suppresses reflections back into the second waveguides which would cause instability to the operation of the amplifier.

In some examples, the mode conversion structure is a tapered waveguide to reduce a diameter of the plurality of second waveguides to a diameter suitable to the photonic integrated switch circuit.

In some examples, integrated optical switch further comprises a second pump laser to increase pump light or to provide resilience against failures of the first pump laser, and the second pump laser in configured to have an output into the input end of the optical splitter.

In some examples, the first wavelength of the pump light from the pump laser is an infrared wavelength, and wherein the second wavelength of the first signal is also an infrared wavelength.

The current disclosure provides an optical transposer for connecting between an optical amplifier and a photonic circuit, the optical amplifier includes a pump laser and a plurality of doped fibers. The optical transposer has an optical splitter connected to the pump laser of the optical amplifier, an input end of the optical splitter is configured to receive an emitted light from the pump laser, and output ends of the optical splitter are configured to carry divided laser light. The transposer also includes: a plurality of first waveguides, where the plurality of first waveguides may or may not be doped, and a first end of one of the plurality of first waveguides respectively connects to one of the plurality of doped fibers in the optical amplifier; a plurality of second waveguides, where a first end of one of the plurality of second waveguides connects to the photonic circuit; a plurality of third waveguides, where the first end of one of the plurality of third waveguides respectively connects to one of the output ends of the optical splitter; and in addition, a plurality of wavelength division multiplexers, herein one of the plurality of second waveguides is multiplexed with one of the plurality of third waveguides into one of the plurality of first waveguides respectively. One of the plurality of third waveguides may comprise a first signal having a second wavelength, and the plurality of first fibers may comprise a second signal, wherein the second signal is an amplified first signal, and wherein the second signal comprises the second wavelength.

In some examples, each of the plurality of wavelength division multiplexers comprises a first terminal, a second terminal, and a third terminal: the first terminal of one of the plurality of wavelength division multiplexers connects to a second end of one of the plurality of first waveguides which connects to the plurality of doped fibers; the second terminal of one of the plurality of wavelength division multiplexers connects to a second end of one of the plurality of second waveguides from the photonic circuit; the third terminal of one of the plurality of wavelength division multiplexers connects to a second end of one of the plurality of third waveguides from the optical splitter.

In some examples, the transposer comprises one of glass, quartz, fused silica, and plastics.

In some examples, the optical transposer further comprises a mode conversion structure disposed between one of the plurality of second waveguides and the photonic circuit.

In some examples, a diameter of the mode conversion structure is tapered such that a diameter of the plurality of second waveguides is reduced to a diameter suitable to the photonic integrated switch circuit.

In some examples, the optical amplifier further comprises a second pump laser configured to increase pump light, wherein the second pump laser is configured of emitting pump light at the first wavelength and connects to the input end of the optical splitter.

According to another embodiment of the current disclosure, a method is provided of fabricating an optical transposer to connect between an optical amplifier and a photonic circuit. The method may comprise steps of: providing a substrate comprising a material of a first dielectric constant; providing an optical splitter, wherein an input end of the optical splitter is configured to receive a light from a pump laser of an optical amplifier, and output ends of the optical splitter are configured to carry divided laser light; forming a plurality of first waveguides, wherein the plurality of first waveguides may be doped and wherein a first end of one of the plurality of first waveguides respectively connects to one of a plurality of doped fibers in the optical amplifier; forming a plurality of second waveguides, wherein a first end of one of the plurality of second waveguides connects to the photonic circuit; and forming a plurality of third waveguides, wherein a first end of one of the plurality of third waveguides respectively connects to one of the output ends of the optical splitter. The plurality of first waveguides, the plurality of second waveguides, and the plurality of third waveguides may comprise a second material of a second dielectric constant, wherein the second dielectric constant is larger than the first dielectric constant at a wavelength of the pump laser and a wavelength of the input signal.

In some examples, the method may further comprise fabricating a plurality of wavelength division multiplexers, wherein each of the plurality of wavelength division multiplexers comprises a first terminal, a second terminal, and a third terminal. The first terminal of one of the plurality of wavelength division multiplexers may connect to a second end of one of the plurality of first waveguides which connects to the plurality of doped fibers; the second terminal of one of the plurality of wavelength division multiplexers may connect to the second end of one of the plurality of second waveguides from the photonic circuit; and the third terminal of one of the plurality of wavelength division multiplexers may connect to a second end of one of the plurality of third waveguides from the optical splitter.

### BRIEF DESCRIPTION OF THE DRAWINGS

Having thus described the invention in general terms, reference will now be made to the accompanying drawings, which are not necessarily drawn to scale, and wherein:

FIG. 1 illustrates a schematic view of the optical switch system according to one embodiment of the current disclosure;

FIG. 2 illustrates a schematic view of the optical transposer structure according to the embodiment of FIG. 1; and

FIG. 3 illustrate a schematic flow chart showing the method of fabricating the optical transposer according to the embodiment of the current disclosure.

### DETAILED DESCRIPTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout. As used herein, terms such as “top,” “bottom,” “front,” etc. are used for explanatory purposes in the examples provided below to describe the relative position of certain components or portions of components. Accordingly, as an example, the term “top current spreading layer” may be used to describe a current spreading layer; however, the current spreading layer may be on the top or on the bottom, depending on the orientation of the particular item being described.

Optical switching is gaining attention as a candidate for an enabling technology because optical switching has the potential for very high data capacity and low power consumption. Optical switching is accomplished using optical switching devices, which have multiple optical input ports for receiving light and output ports to send processed signals to the communication channels in the next stage. The optical switching devices route the light that is coupled to their input ports to the intended output ports on demand, according to one or more control signals, either electrical or optical. Routing of the signals is performed in the optical domain, without the need for optical-electrical and electrical-optical conversions, thus bypassing the need for power-consuming transceivers. Header processing and buffering of the data is not possible in the optical domain, so they are not employed in the optical arena. Instead the packet switching is realized in the networks that consist of electrical switches, using an end-to-end circuit that is created for the communication between two devices as the circuit switching paradigm.

There are several possible deployment options for optical switches in datacenter networks for the corresponding network architecture, such as the use of dynamic bandwidth allocation within the switches of an electrical network, formation of direct optical links as express paths between end hosts, and link hardware.

There are two key requirements in common for all the above applications in the datacenter: low loss and low cost. They are explained in detail below.

The first requirement is that the optical switching must have low cost. Current optical switch technologies are targeting certain applications that have small to medium volumes, for example, the applications in the field of test and measurement or in the field of telecommunication. Introducing optical switching to the datacenter network requires that the cost of the switches does not add significantly to the existing cost of the links. In short-reach optical interconnects, the short-term cost target is 1$/Gb/s, (i.e. one dollar per Gb per second), which means that an 800 Gb/s transceiver is expected to cost roughly $800 or even less with time. As a result, the cost per port of any optical switches should be constrained to a small fraction of this number, such as a few tens of dollars for the 800 Gb/s transceiver. However, the current amount is more than an order of magnitude greater that.

The second requirement of low loss is also critical. Typically optical link protocols foresee moderate link insertion losses and fiber losses, which often accounts for ˜0.5 dB for each optical connector, plus the fiber propagation loss typically accounts for 0.47 dB per km.

Typical link insertion losses for different types of 400 Gb/s transceivers are summarized in Table 1 below.

TABLE 1

| | | | Channel | |
|---|---|---|---|---|
| | | Bandwidth | Insertion | Distance |
| type | Description | (nm) | loss (dB) | (km) |
| 400GBASE-DR4 | PSM4 | 13 | 3 | 0.5 |
| 400GBASE-FR4 | CWDM 4λ | 73 | 4 | 2 |
| 400GBASE-LR4 | CWDM 4λ | 73 | 6.3 | 10 |
| 400G-ER4-Lite | LAN-WDM 4λ | 15.6 | 15 | 30 |
| 400GBASE-ER4 | LAN-WDM 4λ | 15.6 | 18 | 40 |

The typical loss of connectors and splices is in the order of 2 dB per link, making the available optical loss budget for an optical switch very limited even when very short reach of a few hundred meters is considered, especially for the more popular transceiver types such as the -DR4 and -FR4.

In reality, a typical insertion loss for integrated optical switches with even a moderate number of ports can reach or exceed 10 dB. For example, in the case of single-polarization optical switches, a fiber-to-fiber loss of the 32×32 thermo-optic switch can be near 10.8 dB, and a fiber-to-fiber loss of an 8×8 electro-optic switch may be in the range of 7.5 dB-10.5 dB. For diversity circuitry with orthogonal polarizations, one has to consider adding several additional dBs of fiber-to-fiber losses into the total budget for any practical implementation cases.

The exemplary loss performance of such state-of-the-art silicon photonic switches highlights the problem that silicon photonic switches, and integrated switches in general, cannot be used with standard short reach transceivers. To enable an integrated silicon photonic switch, one option will be that the entire transceiver infrastructure of a datacenter would have to be replaced with transceivers of higher cost and long-reach, but this option faces cost and practicality challenges.

Today's datacenters face a multitude of challenges, mainly involving enabling the aggressive scaling of bandwidth and system size while keeping network energy consumption and low latency. The current disclosure facilitates the deployment of integrated optical switches in these datacenters. Optical switching bears the promise of disrupting current scaling trends and providing broad bandwidth with lower latency and meagre energy consumption.

The optical switch has multiple optical inputs/outputs. These inputs/outputs can be in-plane or out-of-plane, for example, they can be spot-size converters, adiabatic couplers, or grating couplers.

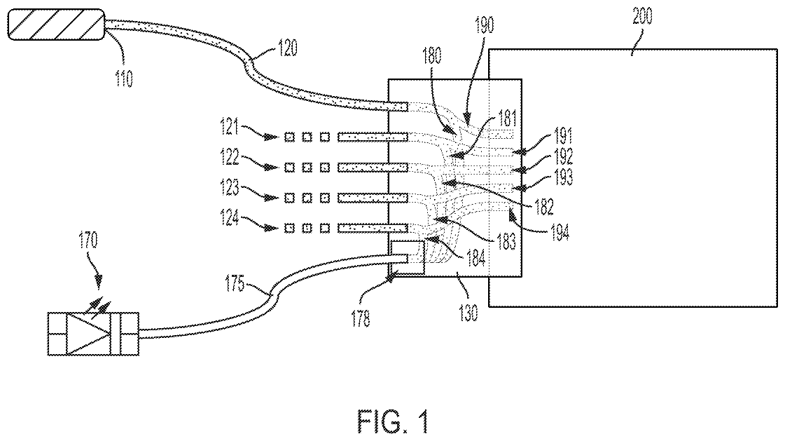

FIG. 1 illustrates a schematic diagram of an integrated optical switch system according to embodiments of the current disclosure. The integrated optical switch system includes a photonic integrated switch circuit 200, a pump laser 170, fiber amplifiers composing a group of doped fibers and/or waveguides 120, 121, 122, 123, 124, wavelength division multiplexing (WDM) components, and a central transposer 130 that facilitates the connection of the photonic integrated circuit 200 and the doped fiber amplifiers.

The pump signal used in doped fiber amplifiers is essentially light at a suitable wavelength, typically shorter than the wavelength of the signal to be amplified, that can excite the ions of the fiber dopants in order to generate optical gain with the initial signals. The pump laser 170 excites ions into a higher energy state from which they can decay via stimulated emission of photons at the signal wavelength back to a lower energy level. The excited ions can also decay spontaneously through spontaneous emission or even through nonradiative processes involving interactions with photons of the fiber glass matrix. However, the doped fiber amplification does not always have a monolithic gain due to the inhomogeneous broadening effects and the polarization effects. Due to the inhomogeneous portion of the linewidth broadening of the dopant ions, the gain spectrum has an inhomogeneous component and gain saturation occurs, to a small extent, in an inhomogeneous manner. This effect is known as spectral hole burning because a high-power signal at one wavelength can ‘burn’ a hole in the gain for wavelengths close to that signal by saturation of the inhomogeneously broadened ions.

Although the doped fiber amplifier is essentially a polarization independent amplifier, a small proportion of the dopant ions interact preferentially with certain polarizations and a small dependence on the polarization of the input signal may occur (typically <0.5 dB). This is called Polarization Dependent Gain (PDG). The absorption and emission cross sections of the ions can be modeled as ellipsoids with the major axes aligned at random in all directions in different glass sites inside the fiber. The random distribution of the orientation of the ellipsoids in a glass produces a macroscopically isotropic medium, but a strong pump laser induces an anisotropic distribution by selectively exciting those ions that are more aligned with the optical field vector of the pump. Also, those excited ions that are aligned with the signal field produce more stimulated emission. The change in gain is thus dependent on the alignment of the polarizations of the pump and signals.

The active gain medium in doped fibers can be doped with rare-earth elements such as erbium, ytterbium, neodymium, dysprosium, praseodymium, thulium, bismuth and holmium. They are related to doped fiber amplifiers, which provide light amplification without lasing.

The erbium-doped fiber amplifier (EDFA) is the most deployed fiber amplifier as its amplification window coincides with the third transmission window of silica-based optical fiber. The core of a silica fiber is doped with trivalent erbium ions (Er³⁺) and can be efficiently pumped with a laser at or near wavelengths of 980 nm and 1480 nm, and gain is exhibited in the 1550 nm region. A combination of 980 nm and 1480 nm pumping is generally utilized in amplifiers.

The pump laser 170, laser output fiber 175 and the laser light splitter 178 provide the multiple light sources of optical pumping energy. A photonic integrated switch circuit 200 provides a number of optical input signals to the waveguides 190, 191, 192, 193 and 194 respectively. A doped optical fiber 120 transports the output signal to an optical port 110. Other doped fibers 121, 122, 123 and 124 shown in FIG. 1 have similar ports like 110 for passing signals just as fiber 120 does, although these ports are not all shown in FIG. 1 for clarity and ease of explanation. The doped fibers are parts of doped fiber amplifiers (DFAs). The number of doped fibers in the system is determined according to need, so they are not limited to the few shown in FIG. 1. An optical transposer 130 connects the signals from the photonic integrated switch circuit 200 at one side to the pump laser and doped fiber amplifiers at the other side.

A doped fiber amplifier is an optical amplifier that uses the doped optical fiber as a gain medium to amplify an optical signal. The pump laser 170 may be a compact diode laser, a DFB laser, or a fiber laser. The pump laser light output is coupled into a pump laser fiber 175 (single-mode or multimode). The laser fiber 175 inputs at an optical splitter 178, and the pump laser energy is split by the optical splitter 178 into a pigtail of multiple pump laser light sources propagating in channels predisposed in the transposer 130.

In FIG. 1, on the same side of the pump laser 170, the optical fiber connector 110 connects the doped fiber 120. An optical fiber connector adjoins optical fibers, and enables quicker connection and disconnection than splicing two fibers together permanently. The fiber connector 110 mechanically couples and aligns the cores of external and internal fibers so light signal can pass into the optical switch with little loss. When the connector 110 serves as the output end of the optical switch system, it is often attached to an optical isolator to attenuate reflections from the connector's facet and/or from the subsequent optical circuitry that the connector connects to. These connectors may also include ferrules. For simplicity, only fiber 120 is shown to connect to 110, but all the other fibers 121, 122, 123, 124, etc. share the same structure and functions as fiber 120. For instance, each of the group of fibers 121, 122, 123, 124, may be connected to one signal via one connector, similar to the connector 110.

In most applications, one pump laser can provide enough pump energy to support a number of fiber amplifiers, but in some applications there might be a need to have more than one pump laser either to provide more than one pumping wavelengths, more energy for more fiber channels or redundancy against pump laser failures. Accordingly, there can be multiple pump lasers providing pumping energy to the fiber 175, although only one pump laser is shown FIG. 1.

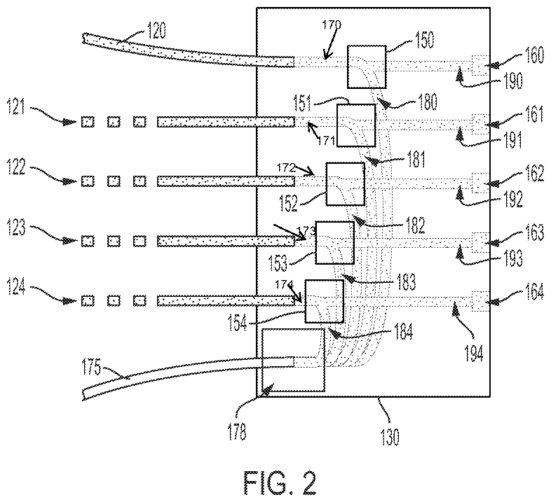

Referring to FIG. 2, the optical transposer structure according to the embodiment of FIG. 1 is shown. The optical transposer 130 serves as the central piece of the optical switch and is located between the photonic integrated switch circuit at one side and pump laser 170 and fiber amplifiers at the other side.

The group of fibers 120, 121, 122, 123 and 124 are connected to the group of waveguides 170, 171, 172, 173, 174 (or fibers) through splicing or adhesives or through array interfacing, respectively. For simplicity, the doped media is referred to as a doped waveguide, but it can be a fiber or another doped light pipe.

As shown in FIG. 2, the interposer 130 includes an optical splitter 178, and an input end of the optical splitter 178 receives the pump light by connecting to the laser output fiber 175. The output ends of the optical splitter carry the split pump light.

The interposer 130 includes three groups of waveguides. The first group of waveguides 170, 171, 172, 173, 174 are waveguides, and the first end of one of the first waveguides 170, 171, 172, 173, 174 connects to another end of one of the doped fibers 120, 121, 122, 123 and 124.

The second group of waveguides 190, 191, 192, 193, 194 are not doped waveguides. The first end of one of the second group of waveguides 190, 191, 192, 193, 194 connects to the photonic integrated switch circuit.

The first end of one of the third group of waveguides 180, 181, 182, 183, 184 connects to one of the output ends of the optical splitter, respectively. The third group of waveguides are not doped waveguides.

In addition, the interposer 130 includes a number of wavelength division multiplexers (WDMs) 150, 151, 152, 153, 154, each of which is configured to multiplex signals from one of the second group of waveguides 190, 191, 192, 193, 194 with laser pump light from one of the third group of waveguides 180, 181, 182, 183, 184 into mixed frequency signals that are directed into one of the first waveguides 170, 171, 172, 173, 174, respectively.

Each of the wavelength division multiplexers 150, 151, 152, 153, 154 has three terminals. The first terminal of each of the wavelength division multiplexers 150, 151, 152, 153, 154 respectively connects to one of the first group of waveguides 170, 171, 172, 173, 174 that are connected with the doped fibers 120, 121, 122, 123 and 124. The second terminal of each of wavelength division multiplexers 150, 151, 152, 153, 154 respectively connects to one of the second group of waveguides 190, 191, 192, 193, 194, which are linked to the photonics integrated switch circuit 200. The third terminal of each of the wavelength division multiplexers 150, 151, 152, 153, 154 respectively connects to the corresponding one of the third group of waveguides 180, 181, 182, 183, and 184, which connect to the output ends of the optical splitter 178 that connects to the laser output fiber 175.

The doped fibers 120, 121, 122, 123 and 124 are connected with the first group of waveguides 170, 171, 172, 173, 174 respectively, so the doped fibers 120, 121, 122, 123, 124 carry a mixture of lights—the laser pump light at a shorter wavelength than that of the light signal from the photonic integrated switch circuit 200. The doped fibers 120, 121, 122, 123, and 124 contain an active medium to facilitate light amplification by the co-propagating pump light in these fibers. Through interaction with the doping ions by the pump light in the fibers 120, 121, 122, 123, and 124, amplification is achieved by stimulated emission of photons from dopant ions in the doped fibers. The excitation-emitted new signal is an amplified signal, which has the same wavelength as the signal from the photonic integrated switch circuit 200.

In some embodiments, the diameter of each of the first waveguides 170, 171, 172, 173, 174, the diameter of each of the second waveguides 190, 191, 192, 193, and 194, and the diameter of each of the third doped waveguides 180, 181, 182, 183, 184 are about the same. However, a photonic integrated switch circuit typically requires a smaller interface size than the fiber size in the range of 2-4 micrometers. As shown in FIG. 2, a group of mode converters 160, 161, 162, 163, 164 may therefore be installed at end of the second group of waveguides 190, 191, 182, 193, and 194 respectively, to make the interface more connectable into the inputs of the photonic integrated switch circuits 200. The mode converters may be waveguide tapers, inverse tapers, evanescent coupling structures, coupled waveguide structures which convert the optical mode size from large, for example, ten micrometers on the fiber side, to a smaller, for example, 2-4-micrometers on the photonic integration circuit side. An additional mode converter may be implemented on the integrated chip to further adapt the optical mode size to that supported by the chip's waveguides, which may be sub-micrometer. Therefore, the transposer 130 may be configured (e.g., sized and shaped) to provide a way of transforming the mode size from the size of a fiber to the size of the photonic integrated circuit interface.

A similar mode conversion structure may be included at the interface between one of the first fibers 120, 121, 122, 123, 124 and its corresponding one of the first waveguides 170, 171, 172, 173, 174.

Thus, the doped fiber pigtails packaged in the transposer 130 simplifies the overall assembly and reduces the number of interfaces in the optical system, thereby reducing optical insertion losses significantly.

The transposer 130 can be fabricated with a material such as glass, quartz, fused silica, or plastic.

On the other side of the transposer 130, the photonic integrated switch circuit 200 may be built on a platform of a photonic chip, often silicon based. A photonic integrated optical circuit is a device that integrates multiple (at least two) photonic functions, similar to an electronic integrated circuit. A photonic integrated circuit differs from an electronic circuit in that it provides functions for information signals imposed on optical wavelengths typically in the visible spectrum or near infrared 850 nm-1650 nm.

Unlike electronic integration where silicon is the dominant material, a photonic integrated circuit system is fabricated from a variety of material systems, including electro-optic crystals such as lithium niobate, silica on silicon, silicon on insulator, various polymers and semiconductor materials that are used to make semiconductor lasers such as GaAs and InP. The different material systems are used because they each provide different advantages and limitations depending on the function to be integrated. For instance, silica/silicon dioxide based photonic integrated circuits have very desirable properties for passive photonic circuits, such as arrayed waveguide gratings, due to their comparatively low losses and low thermal sensitivity. GaAs or InP based photonic integrated circuits allow the direct integration of light sources, and silicon photonic integrated circuits enable co-integration of the photonics with CMOS compatible transistor-based electronics.

The photonic integrated switch circuit 200 is typically implemented in a photonic integration platform with moderate to high index contrast such as silicon photonics. There is a size mismatch from converting optical signals on a fiber connecting to the pigtails of the optical switch. The optical transposer 130 plays the unique role of packaging the waveguide/fiber, splitter, and combiner compactly, so the light is coupled to and from the input/output ports of the photonic integrated circuit 200, according to embodiments of the present invention.

In addition, the pump laser diode 170 can be positioned at a location near of inside the transposer 130 to be close to the multiplexing pigtails. The transposer can also be arranged at a location within the photonic integrated circuit, and this arrangement has the advantage of facilitating heat dissipation and serviceability by providing a removable tray/module.

Depending on the application of the optical switch, input signals may come from the photonic circuit side 200, multiplexed with the pump light through WDM 150 in the interposer 130, amplified by the doped fiber 120 before outputting from the optical connector and isolator 110. In a different application according to other embodiments, the input signals can also come into the connector 110, amplified by the pump light in the doped fiber 120, pass through the multiplexer 150 into the 190 waveguide in the transposer, pass through the mode convertor 160, and finally enter into the photonic integrated switch circuit 200.

The transposer 130 may also contain additional passive optical circuitry, which may allow for combining one or more pump lasers and splitting them among multiple fibers/waveguides (pump light sharing), as well as combining the signals from doped fibers 120, 121, 122, 123, 124 to be amplified by the pump light from 175, such signal combiners also being WDM combiners. The combined signals and pump lights may then be coupled to the switch pigtails, which are implemented with doped fibers. In certain applications, an isolator may be needed, which can be implemented at the input and output sides of each amplifier, such as at the connector 110 or at the transposer 130. An isolator implementation on an optical planar light wave circuit may, in some cases, serve as a transposer.

The transposer may also have another configuration, wherein multiple pump laser fiber pigtails are combined and then split into the multiple amplification paths. In a directional multimode interferometer (MMI) coupler with M×N (M inputs and N outputs) dimensions, light is confined and guided, and thus the MMI is essentially a broad optical waveguide. This enables flexibility in the design, allowing decoupling of the power of a single pump laser with the number of amplifiers or their gains and overall designs. In addition, redundancy is considered so that some redundant pump lasers may be reserved and powered-up in case of failures of the primary pump lasers.

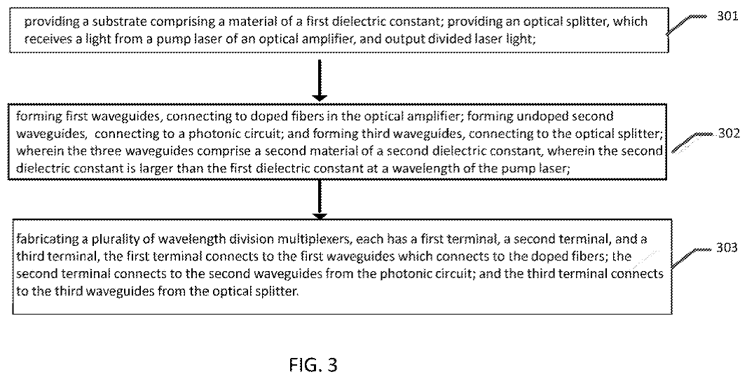

FIG. 3 illustrate a schematic flow chart showing the method of fabricating the optical transposer according to the embodiment of the current disclosure. In step 301: provides a substrate comprising a material of a first dielectric constant; providing an optical splitter, which receives a light from a pump laser of an optical amplifier, and output divided laser light; in step 302: forming first waveguides, connecting to doped fibers in the optical amplifier; forming undoped second waveguides, connecting to a photonic circuit; and forming undoped third waveguides, connecting to the optical splitter; wherein the three waveguides comprise a second material of a second dielectric constant, wherein the second dielectric constant is larger than the first dielectric constant at a wavelength of the pump laser and a wavelength of the input signal; and in step 303: fabricating a plurality of wavelength division multiplexers, each has a first terminal, a second terminal, and a third terminal, herein the first terminal connects to the first waveguides which connects to the doped fibers, the second terminal connects to the second waveguides from the photonic circuit, and the third terminal connects to the third waveguides from the optical splitter.

To sum up, embodiments of the present invention provide the doped fiber pigtails packaged in the transposer 130 so as to simplifying the overall assembly and reducing the number of interfaces in the optical system, thereby reducing optical insertion losses significantly.

More advanced functionalities may be additionally provided by the transposer such as optical isolation, filtering, and polarization management.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. An integrated optical switch, comprising:
a photonic integrated switch circuit;
a pump laser configured to emit a pump light into a laser output fiber, wherein the pump light comprises a first wavelength;
a plurality of first fibers, wherein each of the plurality of first fibers has a first end connecting to an optical connector, wherein the plurality of first fibers is doped; and
a transposer disposed between the plurality of first fibers and the photonic integrated switch circuit, wherein the transposer comprises:
an optical splitter connected to the laser output fiber, wherein an input end of the optical splitter is configured to receive the pump light, and wherein output ends of the optical splitter are configured to carry divided pump light;
a plurality of first waveguides, wherein a first end of one of the plurality of first waveguides connects to a second end of one of the plurality of first fibers;
a plurality of second waveguides, wherein a first end of one of the plurality of second waveguides connects to the photonic integrated switch circuit;
a plurality of third waveguides, wherein a first end of one of the plurality of third waveguides connects to one of the output ends of the optical splitter respectively; and
a plurality of wavelength division multiplexers, wherein one of the plurality of second waveguides is multiplexed with one of the plurality of third waveguides into one of the plurality of first waveguides respectively.

2. The optical switch of claim 1, wherein each of the plurality of wavelength division multiplexers comprises a first terminal, a second terminal, and a third terminal, wherein:
the first terminal of one of the plurality of wavelength division multiplexers connects to a second end of one of the plurality of first waveguides which connects to the plurality of first fibers;
the second terminal of one of the plurality of wavelength division multiplexers connects to a second end of one of the plurality of second waveguides from the photonic integrated switch circuit; and
a third terminal of one of the plurality of wavelength division multiplexers connects to a second end of one of the plurality of third waveguides from the optical splitter.

3. The optical switch of claim 1, wherein one of the plurality of second waveguides comprises a first signal having a second wavelength, and wherein the plurality of first fibers comprises a second signal, wherein the second signal is an amplified first signal, and wherein the second signal comprises the second wavelength.
wherein the first wavelength of the pump laser is shorter than the second wavelength of the first signal.

4. The optical switch of claim 1, further comprising an optical isolator in the optical connector of one of the plurality of first fibers, wherein the optical isolator is configured to suppress reflected light from the optical connector.

5. The optical switch of claim 1, further comprising a mode conversion structure disposed between one of the plurality of second waveguides and the photonic integrated switch circuit.

6. The optical switch of claim 5, wherein a diameter of the mode conversion structure is tapered such that a diameter of the plurality of second waveguides is reduced to a diameter suitable to the photonic integrated switch circuit.

7. The optical switch of claim 1, wherein the plurality of first fibers is doped, and wherein the plurality of first waveguides is doped.

8. The optical switch of claim 1, further comprising a second pump laser configured to increase pump light, wherein the second pump laser is configured to emit pump light at the first wavelength and connects to the input end of the optical splitter.

9. The optical switch of claim 1, wherein the pump laser is configured to emit pump light at the first wavelength that has an infrared wavelength, and wherein the second wavelength of the first signal is also an infrared wavelength.

10. The optical switch of claim 1, wherein the transposer comprises one of glass, quartz, fused silica, and plastics.

11. The optical switch of claim 1, wherein the pump laser is a GaAs/GaAlAs laser diode.

12. The optical switch of claim 1, wherein the first signal is an input signal originating from the photonic integrated switch circuit.

13. An optical transposer for connecting between an optical amplifier and a photonic circuit, wherein the optical amplifier comprises a pump laser and a plurality of doped fibers, the optical transposer comprising:
an optical splitter connected to the pump laser of the optical amplifier, wherein an input end of the optical splitter is configured to receive an emitted light from the pump laser, and wherein output ends of the optical splitter are configured to carry divided laser light;
a plurality of first waveguides, wherein a first end of one of the plurality of first waveguides respectively connects to one of the plurality of doped fibers in the optical amplifier;
a plurality of second waveguides, wherein a first end of one of the plurality of second waveguides connects to the photonic circuit;
a plurality of third waveguides, wherein a first end of one of the plurality of third waveguides respectively connects to one of the output ends of the optical splitter; and
a plurality of wavelength division multiplexers, wherein one of the plurality of second waveguides is multiplexed with one of the plurality of third waveguides into one of the plurality of first waveguides respectively.

14. The optical transposer of claim 13, wherein each of the plurality of wavelength division multiplexers comprises a first terminal, a second terminal, and a third terminal, wherein:
the first terminal of one of the plurality of wavelength division multiplexers connects to a second end of one of the plurality of first waveguides which connects to the plurality of doped fibers;
the second terminal of one of the plurality of wavelength division multiplexers connects to a second end of one of the plurality of second waveguides from the photonic circuit;
the third terminal of one of the plurality of wavelength division multiplexers connects to a second end of one of the plurality of third waveguides from the optical splitter; and
wherein one of the plurality of third waveguides comprises a first signal having a second wavelength, and wherein the plurality of first fibers comprises a second signal, wherein the second signal is an amplified first signal, and wherein the second signal comprises the second wavelength.

15. The optical transposer of claim 13, wherein the plurality of first waveguides is doped.

16. The optical transposer of claim 13, further comprising a mode conversion structure disposed between one of the plurality of second waveguides and the photonic circuit.

17. The optical transposer of claim 13, wherein a diameter of the mode conversion structure is tapered such that a diameter of the plurality of second waveguides is reduced to a diameter suitable to the photonic integrated switch circuit.

18. The optical transposer of claim 13, wherein the optical amplifier further comprises a second pump laser configured to increase pump light, wherein the second pump laser is configured to emit pump light at the first wavelength and connects to the input end of the optical splitter.

19. A method of fabricating an optical transposer to connect between an optical amplifier and a photonic circuit, the method comprising steps of:
providing a substrate comprising a material of a first dielectric constant;
providing an optical splitter, wherein an input end of the optical splitter is configured to receive a light from a pump laser of an optical amplifier, and output ends of the optical splitter are configured to carry divided laser light;
forming a plurality of first waveguides, wherein a first end of one of the plurality of first waveguides respectively connects to one of a plurality of doped fibers in the optical amplifier;
forming a plurality of second waveguides, wherein a first end of one of the plurality of second waveguides connects to the photonic circuit; and
forming a plurality of third waveguides, wherein a first end of one of the plurality of third waveguides respectively connects to one of the output ends of the optical splitter; and
wherein the plurality of first waveguides, the plurality of second waveguides, and the plurality of third waveguides comprise a second material of a second dielectric constant, wherein the second dielectric constant is larger than the first dielectric constant at a wavelength of the pump laser and a wavelength of a signal in the second waveguide.

20. The method of fabricating an optical transposer as in claim 19, further comprising:
fabricating a plurality of wavelength division multiplexers, wherein each of the plurality of wavelength division multiplexers comprises a first terminal, a second terminal, and a third terminal;
connecting the first terminal of one of the plurality of wavelength division multiplexers to a second end of one of the plurality of first waveguides which connects to the plurality of doped fibers;
connecting the second terminal of one of the plurality of wavelength division multiplexers to a second end of one of the plurality of second waveguides from the photonic circuit; and
connecting a third terminal of one of the plurality of wavelength division multiplexers to a second end of one of the plurality of third waveguides from the optical splitter.
